(19) United States
(12) Patent Application Publication
(10) Pub. No.: US 2010/0212798 A1
(43) Pub. Date: Aug. 26, 2010

(54) TIRE PRESSURE INFLATION SYSTEM

(75) Inventor: Steven P. Bothe, JR., Newnan, GA (US)

Correspondence Address: GLOBAL IP COUNSELORS, LLP, 1233 20TH STREET, NW, SUITE 700, WASHINGTON, DC, 20036-2680, US

(73) Assignee: NISSAN TECHNICAL CENTER NORTH AMERICA, INC., Farmington Hills, MI (US)

(21) Appl. No.: 12/390,162

(22) Filed: Feb. 20, 2009

(51) Int. Cl. B60C 23/10

(52) U.S. Cl. 152/415

(57) ABSTRACT

A tire pressure inflation system includes an inflation device having a communication portion and an inflation portion. The communication portion is configured to receive tire pressure signals wirelessly transmitted from a tire pressure sensor disposed within a vehicle tire cavity. The inflation portion is configured to change pressure within the pressurized vehicle tire cavity in response to signals from the tire pressure sensor.

### BACKGROUND OF THE INVENTION

1. Field of the Invention

The present invention relates to tire pressure inflation system. More specifically, the present invention relates to a tire pressure inflation system that includes a device with means to remotely detect air pressure within a tire by receiving transmitted low air pressure signals from a tire pressure sensor with the tire, and supply compressed air in response to the low air pressure signal from the tire pressure sensor.

2. Background Information

Many vehicles are equipped with tire pressure sensors that detect or measure air pressure within the tire cavity of a tire. The tire pressure sensor transmits signals indicative of the air pressure within the tire cavity of the tire. The transmitted signals are typically received by a receiving device within the vehicle. If the signal from the tire pressure sensor indicates that the tire air pressure is low, a light is illuminated on the dashboard alerting the driver to the tire's condition.

While such a system within a vehicle is advantageous for alerting the driver of a potential tire problem, this system is only utilized by the vehicle for the driver's benefit.

In view of the above, it will be apparent to those skilled in the art from this disclosure that there exists a need for an improved tire pressure system that allows for more versatile use of the signals transmitted by the tire pressure sensors. This invention addresses this need in the art as well as other needs, which will become apparent to those skilled in the art from this disclosure.

### SUMMARY OF THE INVENTION

One object of the present invention is to provide an inflation device with means to wirelessly communicate with wireless electronic tire pressure sensors.

Another object of the present invention is to provide an inflation device with means to wirelessly check air pressure within a tire.

In accordance with one aspect of the present invention, a tire pressure inflation system includes an inflation device having a communication portion and an inflation portion. The communication portion is configured to receive tire pressure signals wirelessly transmitted from a tire pressure sensor disposed within a vehicle tire cavity. The inflation portion is configured to change pressure within the pressurized vehicle tire cavity in response to signals from the tire pressure sensor.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic view of a tire pressure inflation system that includes an inflation device and a tire pressure sensor within a tire of a vehicle in accordance with a first embodiment of the present invention;

FIG. 2 is a schematic view of the inflation device showing the inflation device with one of the tires of the vehicle shown in FIG. 1, the tire having the tire pressure sensor in accordance with the first embodiment of the present invention;

FIG. 3 is a schematic representation of the basic components of the tire pressure sensor shown removed from the tire in accordance with the first embodiment of the present invention;

FIG. 4 is a schematic view of a tire pressure inflation system that includes an inflation device installed within a vehicle, and a tire pressure sensor within a tire of the vehicle in accordance with a second embodiment of the present invention;

FIG. 5 is a side elevational view of a stand alone inflation device of a tire pressure inflation system in accordance with a third embodiment of the present invention;

FIG. 6 is a side schematic view of a vehicle that includes a tire pressure sensor in accordance with a fourth embodiment of the present invention;

FIG. 7 is a flowchart showing basic steps of a first operation of the tire pressure inflation system in accordance with the present invention;

FIG. 8 is a flowchart showing basic steps of a second operation of the tire pressure inflation system in accordance with the present invention;

FIG. 9 is a flowchart showing basic steps of a third operation of the tire pressure inflation system in accordance with the present invention; and

FIG. 10 is a flowchart showing basic steps of a forth operation of the tire pressure inflation system in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

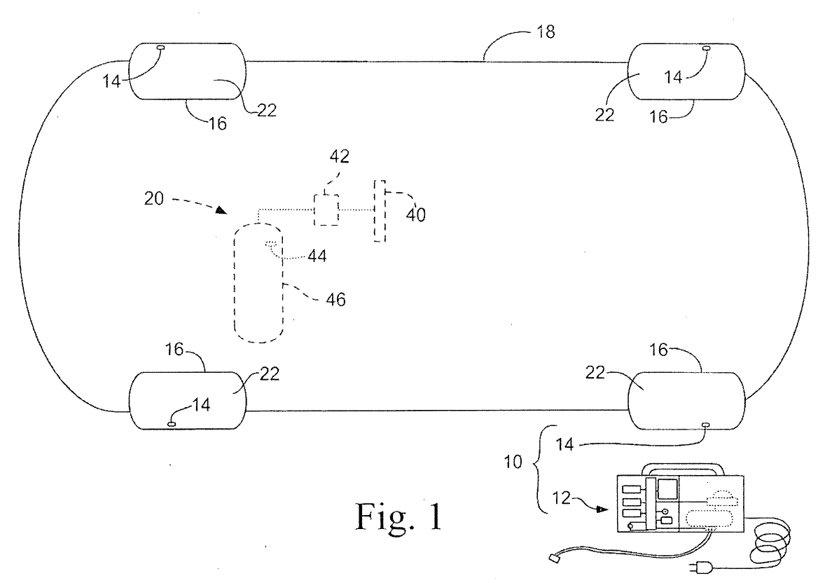

Referring initially to FIG. 1, a tire pressure inflation system 10 is illustrated in accordance with a first embodiment of the present invention. The tire pressure inflation system 10 includes an inflation device 12 and a tire pressure sensor 14 within a conventional tire 16 of a vehicle 18. The inflation device 12 and tire pressure sensor 14 of the tire pressure inflation system 10 are described in greater detail below.

The vehicle 18 is shown schematically in FIG. 1. The vehicle 18 includes, among other things, four tires 16 and a tire pressure monitoring system 20. Each of the tires 16 has a tire cavity 22 that is able to hold compressed air in a conventional manner. Further, each of the tires 16 is preferably inflated to a prescribed air pressure. The prescribed air pressure within the tire cavity 22 varies from tire to tire depending upon usage, the design of the tire and the design of the vehicle 18. For example, if the vehicle 18 is a small or mid-sized passenger vehicle, the prescribed air pressure is typically between 28 and 32 psi (pounds per square inch). However, if the tires are installed to a large vehicle such as a truck, van, bus, mobile home, tractor or large commercial vehicle, the prescribed air pressure is significantly greater than that of a passenger vehicle.

It should be understood from the drawings and the description herein, that the inflation device 12 and tire pressure sensor 14 of the tire pressure inflation system 10 of the present invention can be used in or with any such vehicles, such as those mentioned above. Further the vehicle 18 depicted in the drawings represents any of the above mentioned vehicles.

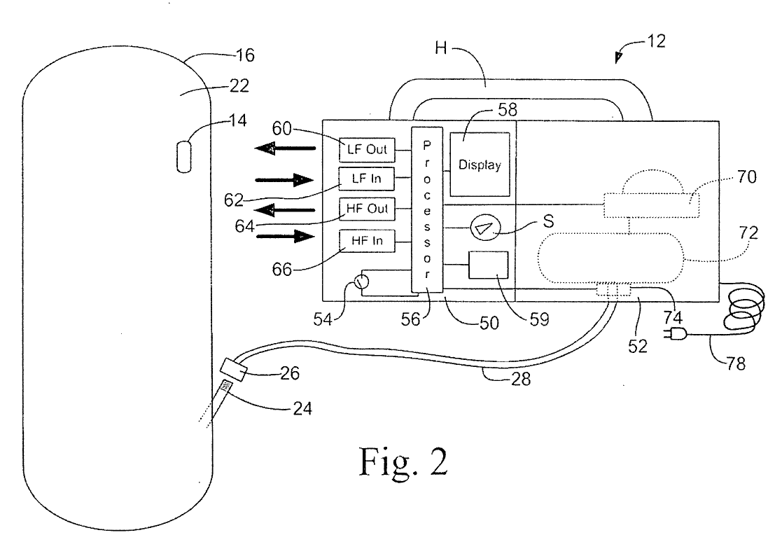

As indicated in FIG. 2, each of the tires 16 includes a conventional valve stem 24 that is configured to receive compressed air, and direct and retain the compressed air within the tire cavity 22 of the tire 16. Further, the valve stem 24 is dimensioned to mate with a nozzle 26 of a pneumatic hose 28, such as that shown in FIG. 2, allowing pressurized air to be directed into the tire cavity 22. A conventional spring biased valve element (not shown) within the valve stem 24 inhibits the flow of air out of the tire cavity 22.

With reference again to FIG. 1, each of the tires 16 also preferably includes one of the tire pressure sensors 14. It should be understood from the drawings and description herein, that each of the tire pressure sensors 14 is the same. Therefore, description of one tire pressure sensor 14 applies to all of the tire pressure sensors 14. Consequently, description of only one tire pressure sensor 14 is provided for the sake of brevity.

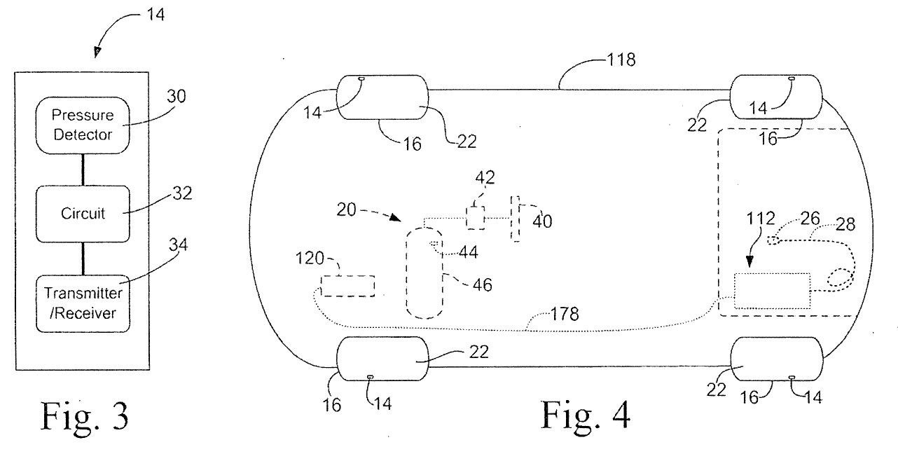

As shown in FIG. 3, the tire pressure sensor 14 includes a pressure detector 30, a control circuit 32 and a transmitter/receiver 34 powered by a small battery (not shown). The tire pressure sensor 14 is configured to monitor the air pressure within the tire cavity 22. Specifically, the pressure detector 30 is a conventional element that detects air pressure acting on it. The pressure detector 30 can be made of any of a variety of conventional elements and/or materials sensitive to pressure and changes in pressure. The control circuit 32 is electronically connected to the pressure detector 30 and monitors changes in the air pressure measured and/or detected by the pressure detector 30.

The control circuit 32 includes conventional circuitry, such as, for example, a small microprocessor, RAM, ROM, etc., that translates the measured changes in pressure detected by the pressure detector 30 into signals that are transmitted via the transmitter receiver 34. The control circuit 32 can also include or be programmed to include a pressure calibration section (not shown). The pressure calibration section includes programming or predetermined data that corresponds to an air pressure threshold for the associated tire 16. The air pressure threshold is a minimum air pressure required for the tire 16 where the tire pressure sensor 14 is installed. The air pressure threshold corresponds to the preferred inflation pressure for desired operation and safely of the tire 16. The pressure calibration section is programmed or otherwise provided with information corresponding to minimum air pressure requirements of the tire 16.

The control circuit 32 detects the air pressure measured by the pressure detector 30. If the detected air pressure is below the minimum air pressure or prescribed air pressure, the control circuit 32 is programmed or configured to transmit a low pressure signal via the transmitter/receiver 34. Similarly, if the detected air pressure is above a maximum air pressure or prescribed air pressure, the control circuit 32 is programmed or configured to transmit a high pressure signal via the transmitter/receiver 34.

The control circuit 32 can be configured in any of a variety of ways with respect to transmitting signals corresponding to a low pressure reading. For example, in one embodiment, the control circuit 32 is an automated circuit that is programmed or otherwise configured to read the signals from the air pressure detector 30 at predetermined intervals, such as once every five minutes or once every 10 minutes and transmit a signal representing the current air pressure within the tire 16.

Alternatively, the control circuit 32 is programmed or otherwise configured to transmit, a signal corresponding to low pressure only when the air pressure within the tire cavity 22 changes.

In yet another alternative embodiment, the control circuit 32 programmed or otherwise configured to respond to predetermined signals received by the transmitter/receiver 34. When such signals are received, the control circuit 32 lakes a measurement of air pressure from the pressure detector 30, and transmits a signal representing the current air pressure within the tire 16.

Further, the control circuit 32 can be configured to process ranges of air pressures detected within the tire cavity 22 by the pressure detector 30 and operate the transmitter/receiver 34 to transmit corresponding signals indicating whether or not the air pressure within the tire cavity 22 is within the range of air pressures.

The control circuit 32 can also be provided with diagnostic algorithms such that the control circuit 32 can run self diagnostic procedures on the transmitter/receiver 34 and the pressure detector 30.

The transmitter/receiver 34 of the tire pressure sensor 14 is a wireless transmitter that is configured in any of a variety of ways. For example, the transmitter/receiver 34 can be configured to transmit only. Specifically, the transmitter/receiver 34 can be configured to transmit a simple signal from the control circuit 32 indicating a problem with the air pressure within the tire cavity 22. Alternatively, the transmitter/receiver 34 can be configured to transmit a series of signals representing the measured air pressure within the tire cavity 22.

The transmitter/receiver 34 can also be configured to receive signals from the inflation device 12 and provide those signals to the control circuit 32. The transmitter/receiver 34 can be configured to send and receive both high frequency and low frequency signals. The low frequency signals are preferably transmitted and received at 125 kHz. The high frequency signals are preferably transmitted and received at one or more 315 MHz, 433-434 MHz, 448 MHz. 868 MHz, or 915 MHz.

As indicated in FIG. 1, the tire pressure monitoring system 20 of the vehicle 18 includes at least one transmitter/receiver 40, a controller 42 and a display 44. The transmitter/receiver 40 is configured to transmit and receive signals from the transmitter/receiver 34 of each of the tires pressure sensors 14 in corresponding ones of the tires 16. The controller 42 is configured to process signals from the transmitter/receiver 40 and display a tire pressure problem indication on the display 44. The display 44 can be a light on a dashboard 46 of the vehicle 18 representing a tire pressure problem or can be a display on dashboard 46 of the vehicle displaying the measured air pressure in each tire 16.

It should be understood from the drawings and the description herein that the tire pressure monitoring system 20 of the vehicle 18 can be a simple conventional system that lights up an image on the dashboard or instrument panel indicating a tire pressure problem. Alternatively, the tire pressure monitoring system 20 of the vehicle 18 can be a more sophisticated system that provides the driver of the vehicle 18 with information relating to the status of each of the four tires 16.

A description of the inflation device 12 of the tire pressure inflation system 10 is provided now with specific reference to FIG. 2. In the depicted embodiment, the inflation device 12 is a stand alone unit that is portable. More specifically, the inflation device 12 has a handle H and can be picked up and carried around by a technician or the vehicle driver. The inflation device 12 has a communication portion 50 and an inflation portion 52.

The communication portion 50 is a wireless signal transmitting section of the inflation device 12 that basically includes a control switch 54, a processor 56, a display 58, a low frequency OUT section 60, a low frequency IN section 62, a high frequency OUT section 64, a high frequency IN section 66 and a mode switch S. The communication portion 50 is configured to receive tire pressure signals wirelessly transmitted from each of the tire pressure sensors 14 disposed within the tire cavity 22 of respective ones of the tires 16.

The inflation portion 52 of the inflation device 12 includes a compressor 70, a compressed air reservoir 72, a pressure gauge 74, the tire stem nozzle 26 and the pneumatic hose 28. The inflation portion 52 is configured provide compressed air upon demand in order to change pressure within the tire cavity 22 in response to signals from the tire pressure sensor 14.

The control switch 54 is configured to selectively provide power to all powered elements of the inflation device 12. When switched to an ON position, the control switch 54 provides power to the inflation device 12. When switched to an OFF position, the control switch 54 cuts all power to the inflation device 12.

The processor 56 includes memory 59 and is configured or programmed to process signals to and from the low frequency OUT section 60, the low frequency IN section 62, the high frequency OUT section 64 and the high frequency IN section 66. Specifically when either the low frequency IN section 62 and/or the high frequency IN section 66 of the inflation device 12 receives a signal or signals from one of the tire pressure sensors 14, the processor 56 determines the meaning of the signal and responds accordingly. For example, if the signal received indicates low air pressure in the corresponding one of the tires 16, the processor 56 causes corresponding information to be displayed on the display 58.

Hence, the low frequency IN section 62 of the communication portion 50 of the inflation device 12 is configured to receive low frequency wireless signals from the transmitter/receiver 34 of the tire pressure sensor 14, if the tire pressure sensor 14 is configured for low frequency transmitting. The high frequency IN section 66 of the communication portion 50 of the inflation device 12 is configured to receive high frequency wireless signals from the transmitter/receiver 34 of the tire pressure sensor 14, if the tire pressure sensor 14 is configured for high frequency transmitting.

Further, the low frequency OUT section 60 of the communication portion 50 of the inflation device 12 is configured to transmit low frequency wireless signals to the transmitter/receiver 34 of the tire pressure sensor 14, if the tire pressure sensor 14 is configured for low frequency reception. The high frequency OUT section 64 of the communication portion 50 of the inflation device 12 is configured lo transmit high frequency wireless signals to the transmitter/receiver 34 of the tire pressure sensor 14, if the tire pressure sensor 14 is configured for high frequency reception.

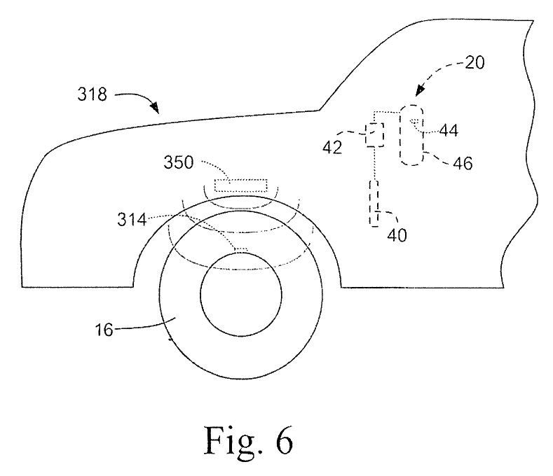

The mode switch S is an optional feature and is connected to the processor 56 and provides a means for selecting the specific operation of the inflation device 12. Examples of operation modes are provided below and described with reference to FIGS. 6-9.

Additionally, in an alternative embodiment, the low frequency IN section 62 of the communication portion 50 of the inflation device 12 is configured to receive low frequency wireless signals from the transmitter/receiver 40 of the tire pressure monitoring system 20 of the vehicle 18, if the tire pressure monitoring system 20 is configured for low frequency transmission. The high frequency IN section 66 of the communication portion 50 of the inflation device 12 is configured lo receive high frequency wireless signals from the transmitter/receiver 40 of the tire pressure monitoring system 20 of the vehicle 18, if the tire pressure monitoring system 20 is configured for high frequency transmission.

Further, the low frequency OUT section 60 of the communication portion 50 of the inflation device 12 is configured to transmit low frequency wireless signals to the transmitter/receiver 40 of the tire pressure monitoring system 20 of the vehicle 18, if the tire pressure monitoring system 20 is configured for low frequency reception. The high frequency OUT section 64 of the communication portion 50 of the inflation device 12 is configured to transmit high frequency wireless signals to the transmitter/receiver 40 of the tire pressure monitoring system 20 of the vehicle 18, if the tire pressure monitoring system 20 is configured for high frequency reception.

In an alternative embodiment, the processor 56 can be configured or programmed to control operation of the compressor 70. Specifically, if the signals received by the low frequency IN section 62 and/or the high frequency IN section 66 indicate a low pressure in the corresponding tire 16, and the nozzle 26 of the pneumatic hose 28 is connected to the valve stem 24 of the corresponding tire 16, the processor 56 operates the compressor 70 supplying compressed air to the tire 16 until the tire 16 reaches the prescribed tire pressure. Once the tire pressure sensor 14 detects air pressure within the tire cavity 22 corresponding to the prescribed tire pressure, and the appropriate signal has been received by the communication portion 50 of the inflation device 12, the processor 56 stops the compressor 70.

However, it should be understood from the drawings and the description herein, that the compressor 70 and nozzle 26 can be manually operated to supply compressed air to one of the tires 16 manually, independent from the processor 56.

The processor 56 is also configured or programmed to transmit signals via the low frequency OUT section 60 and/or the high frequency OUT section 64 to the tire pressure sensor 14 requesting a tire pressure measurement.

The use of high frequency signals and low frequency signals is typically determined by the type of tire pressure sensor 14 installed in the tires 16. In some vehicles, the tire pressure sensors 14 are configured to transmit and optionally receive low frequency signals. In other vehicles, the tire pressure sensors 14 are configured to transmit and optionally receive high frequency signals. The communication portion 50 of the inflation device 12 is configured to send and receive low frequency transmissions at 125 kHz and high frequency transmissions at one of 315 MHz, 433-434 MHz, 448 MHz. 868 MHz, and 915 MHz.

It should be understood from the drawings and the description herein that the inflation device 12 can also be configured with either low frequency wireless communication or high frequency wireless communication. However, in the depicted embodiment, both low and high frequency wireless communication is included.

The processor 56 of the communication portion 50 of the inflation device 12 is configured to transmit a request signal to the tire pressure sensor 14 requesting tire pressure signals from the tire pressure sensor 14. In response, the tire pressure sensor 14 transmits a signal indicating the air pressure status of the corresponding tire 16.

Consequently, the inflation device 12 is a stand alone unit that includes a battery (not shown) for power, or as depicted in FIGS. 1 and 2, a power cable 78 for power. In the embodiment depicted in FIGS. 1 and 2, the inflation device 12 is a portable device that can be carried around using the handle H. In a preferred embodiment, the power cable 78 is depicted as a conventional 110-120 or 220-240 volt power cord that provides power to the communication portion 50 and the inflation portion 52. Hence, in the preferred embodiment, the compressor 70 and all circuitry within the inflation device 12 (including the communication portion 50) uses 110-120 or 220-240 volts or is powered by a power transformer (not shown) that reduces the voltage accordingly. Hence, the inflation device 12 is a portable unit having a power cord or power cable 78 that receives standard alternating current.

However, in an alternative embodiment, inflation device 12 can be configured to operate with only 12 volts of power. In this alternative embodiment, the power cable 78 includes either a cigarette lighter sized power adapter for insertion into a cigarette lighter (not shown) of the vehicle 18, or a pair of clips that are attachable to the terminals (not shown) of a battery (not shown) of the vehicle 18.

With the inflation device 12 having portable capabilities, die inflation device 12 can be carried around the vehicle 18 from tire to tire. The inflation device 12 wirelessly communicates with the tire pressure sensor 14 in each tire and supplies compressed air into the tire 16 upon demand either manually or automatically, as described above.

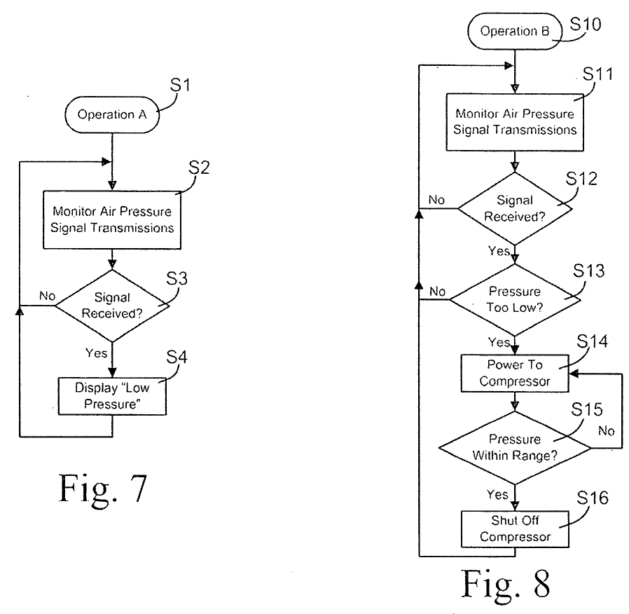

The description below includes second and third embodiments of the present invention. Although several embodiments of the present invention are described herein, the operations and features of the first, second and third embodiments, are the basically the same and are represented in the flowcharts depicted in FIGS. 7-10.

### Second Embodiment

Referring now to FIG. 4, an inflation device 112 within a vehicle 118 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment maybe omitted for the sake of brevity.

The inflation device 112 has all the same elements as the inflation device 12 of the first embodiment, such as the communication portion 50 and the inflation portion 52. However, the inflation device 112 in the second embodiment is installed within the vehicle 118. The inflation device 112 is connected to a battery 120 of the vehicle 118 via a power cable 178 and is powered by the battery 120. Hence, all the components of the inflation device 112, such as the communication portion 50 and the compressor 70 of the inflation portion 52, all operate on 12 volts.

The communication portion 50 of the inflation device 112 includes the low frequency OUT section 60, the low frequency IN section 62, the high frequency OUT section 64 and the high frequency IN section 66. However alternatively, the communication portion 50 can be electronically or wirelessly connected to the tire pressure monitoring system 20 of the vehicle 118. Thus, the inflation device 112 can detect the air pressure within the tires 16 either by communication with the tire pressure sensors 14, or by communicating with the tire pressure monitoring system 20 of the vehicle 118.

### Third Embodiment

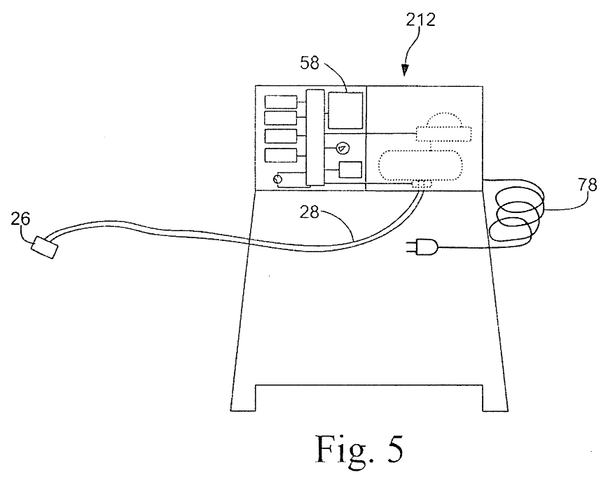

Referring now to FIG. 5, an inflation device 212 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

The inflation device 212 has all the same elements as the inflation device 12 of the first embodiment such as the communication portion 50 and the inflation portion 52. However, in the second embodiment, the inflation device 212 is a stationary unit having a power cord that receives standard alternating current. Hence, the inflation device 212 runs on conventional 110 volt power and is configured for use in a repair facility or a home garage.

### Fourth Embodiment

Referring now to FIG. 6, a vehicle 318 that includes a tire pressure sensor 314 in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity.

The tire pressure sensor 314 is identical to the tire pressure sensor 14 depicted in FIG. 3 except that the power source for the tire pressure sensor 314 differs from that of the tire pressure sensor 14 of the first embodiment. Specifically, the tire pressure sensor 314 includes the pressure detecting portion 30 (not shown in FIG. 6), the control circuit 32 (not shown in FIG. 6) and the transmitter/receiver 34 (not shown in FIG. 6) described above with respect to FIG. 3. However, power for the tire pressure sensor 314 is not necessarily provided by a conventional battery, as with the tire pressure sensor 14.

The tire pressure sensor 314 includes a coil (not shown) that is sensitive to magnetic fields. The vehicle 318 includes a magnet or coil 350 that induces a magnetic field that permeates the tire 16. As the tire 16 rotates, the tire pressure sensor 314 rotates with the tire 16 and the tire pressure sensor 314 passes repeatedly though the lines of force of the magnetic field of the coil 350. As the coil (not shown) of the tire pressure sensor 314 passes through the lines of force, an electrical charge is generated within the tire pressure sensor 314. The tire pressure sensor 314 uses the induced electric current to power itself. The tire pressure sensor 314 can further be provided with a small rechargeable battery or a capacitor that serves as a short term battery providing brief, but sustained power to operate the pressure detecting portion 30, the control circuit 32 and the transmitter/receiver 34 of the tire pressure sensor 314.

With the rechargeable configuration of the tire pressure sensor 314, the vehicle 318 also preferably includes the tire pressure monitoring system 20, with its transmitter/receiver 40, its controller 42 and its display 44. One of the inflation devices 12, 112 and/or 212 can then communicate with the tire pressure monitoring system 20 and obtain tire pressure information corresponding to the air pressure within the tire 16.

### Operation of Present Invention

Referring now to FIGS. 7-10, flowcharts show representations of several basic operations of the tire pressure inflation system 10. More specifically, the flowcharts depicted in FIGS. 7-10, show representations of basic operations of programmed or configured into the inflation devices 12, 112 and/or 212. In the following description, specific reference is made to operations performed by the inflation device 12. However, it should be understood from the drawings and the description herein that the operations described below and shown in the flowcharts in FIGS. 7-10 also apply to the inflation devices 112 and 212 of the second and third embodiments. For the sake of brevity, only the inflation device 12 is referred to in the following description.

Operations A, B, C and D are depicted in FIGS. 7, 8, 9 and 10, respectively. The inflation device 12 can be programmed or configured to perform some or all of these operations, depending upon designer preference. For example, a simplified version of the inflation device 12 can be configured to include only operation A. A more complex version of the inflation device 12 can include more capabilities having two, three or all four of the operations A, B, C and D described below.

The mode switch S can optionally be provided on the inflation device 12 so that a user can select the specific mode of operation.

The specific operation performed by the inflation device 12 in part depends upon the configuration of the fire pressure sensor 14. For instance, if the tire pressure sensor 14 only transmits a simple signal at predetermined intervals indicating that either air pressure within the tire cavity 22 is acceptable or that the air pressure is low, then the inflation device 12 performs operation A only. If the tire pressure sensor 14 is configured to transmit signals representing detected tire pressure, then the inflation device 12 performs operations B and/or D. If the tire pressure sensor 14 is configured to transmit signals only when a transmit signal request is made by the inflation device 12, the operation C is performed.

It should also be understood from the drawings and description herein, that the inflation device 12 can include any one, combinations of these modes of operation or all of the described modes of operation.

As shown in FIG. 7, the first mode of operation, operation A, starts at step S1, where the control switch 54 of the inflation device 12 is turned on, providing power to the communication portion 50 and the inflation portion 52 of the inflation device 12. At step S2, the processor 56 begins monitoring for wireless signals received by either one of the low frequency IN section 62 and/or the high frequency IN section 66. At step S3, a decision is made. Specifically, if a nearby one of the tire pressure sensors 14 and/or the tire pressure monitoring system 20 of the vehicle 18 transmits a signal that is received by the communication portion 50, operation moves to step S4 and a message corresponding to the received signal is displayed. For example, the message displayed can be a “Low Air Pressure” message, a “High Air Pressure” message, or the actual measured air pressure can be displayed. The type of message displayed depends upon the signal transmitted by of the tire pressure sensors 14 and/or the tire pressure monitoring system 20 of the vehicle 18.

If no signal is displayed, the processor 56 continues to monitor for air pressure signal transmissions al steps S2 and S3.

Referring now to FIG. 8, operation B is described below. Specifically, at step S10, the control switch 54 of the inflation device 12 is turned on and/or the mode switch S is operated to select operation B. In the following operation, the nozzle 26 is connected to the valve stem 24 of a nearby one of the tires 16. Further signals relating to the nearby one of the tires 16 are being transmitted by the tire pressure sensors 14 and/or the tire pressure monitoring system 20 of the vehicle 18.

At step S11, the processor 56 begins monitoring for wireless signals received by either one of the low frequency IN section 62 and/or the high frequency IN section 66. At step S12, a decision is made. Specifically, if a nearby one of the tire pressure sensors 14 and/or the tire pressure monitoring system 20 of the vehicle 18 has transmitted a signal received by the communication portion 50, operation moves to step S13. If no message is received, operation returns to step S11.

At step S13, another determination is made. At step S13, if a low pressure signal is received, operation moves to step S14 where the compressor 70 is provided with power by the processor 56. Since the nozzle 26 is connected to the valve stem 24 of the nearby one of the tires 16, compressed air is pumped into the tire cavity 22 of the nearby one of the tires 16. Operation then moves to step S15 where signals from the nearby one of the tire pressure sensors 14 and/or the tire pressure monitoring system 20 of the vehicle 18 are again monitored. A decision is made at step S15, depending upon the signals received. If the received signal indicates that the pressure in the nearby one of the tires 16 is not within the prescribed air pressure range (for example, the measured air pressure is not above a minimum air pressure) then operation returns to step S14 where power continues being provided to the compressor 70 and compressed air continues to be provided into the tire cavity 22 of the tire 16. However, at step S15, once the received signal indicates that pressure in the nearby one of the tires 16 is within the prescribed air pressure range (above the minimum air pressure), then operation moves to step S16. At step S16, the compressor 70 is shut off.

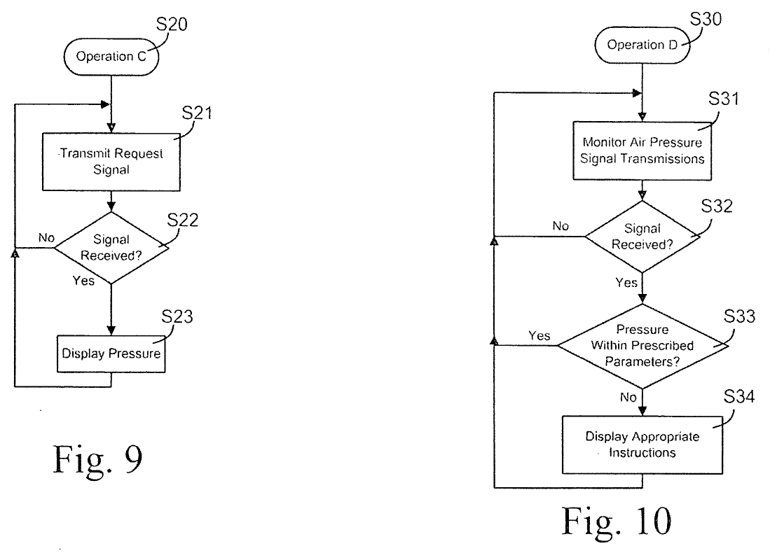

Referring now to FIG. 9, a flowchart shows a representation of operation C of the inflation device 12. Specifically, at step S20, the control switch 54 of the inflation device 12 is turned on and/or the mode switch S is operated to select operation C.

At step S21, the processor 56 of the communication portion 50 of the inflation device 12 transmits a signal to the tire pressure sensor 14 requesting tire pressure information. At step S22, a determination is made whether or not a signal has been received. If a signal has been received, then the signal is processed such that the detected air pressure is displayed on the display 58 at step S23. If no signal has been received, operation returns to step S21.

Referring now to FIG. 10, a flowchart shows a representation of operation D of the inflation device 12. Specifically, at step S30, the control switch 54 of the inflation device 12 is turned on and/or the mode switch S is operated to select operation D.

At step S31, the processor 56 of the communication portion 50 of the inflation device 12 monitors for air pressure signal transmissions. At step S32, a determination is made whether or not a signal has been received. If a signal has been received, then at step S33 the signal is processed to determine whether or not the detected air pressure is within prescribed parameters for the vehicle 18. If the air pressure is not within prescribed parameters, an appropriate message or instructions are displayed on the display 58. For instance the message can indicate that: the tire 16 or tires 16 have appropriate levels of air pressure; the tire 16 or tires 16 have low pressure and need to have air added; the tire 16 or tires 16 have levels of air pressure that are greater than the prescribed air pressure and needs to be lowered; or, the tire pressure sensor 14 has a problem and needs to be serviced or replaced.

At step S32 if no signal is received, operation returns to step S31. At step S33, if the air pressure is within prescribed parameters, operation returns to step S31.

Operations A, B, C and D are examples of the type of operations possible with the inflation device 12. It should be understood from the drawings and description herein that the inflation device 12 can have additional features corresponding to additional features of the tire pressure sensors 14 and the tire pressure monitoring system 20 of the vehicle 18. For example, the inflation device 12 can include a wiring harness (not shown) that connects to the vehicle 18 such that the communication portion 50 of the inflation device 12 communicates with systems of the vehicle 18. Specifically, the inflation device 12 can communicate directly with the tire pressure monitoring system 20. Communication between the inflation device 12 and the tire pressure monitoring system 20 of the vehicle 18 can include recent tire air pressure information. Specifically, recently received signals from the tire pressure sensor or sensors 14 representing gradual losses in air pressure or unusual fluctuations in air pressure can be stored by the tire pressure monitoring system 20. This stored information can be downloaded to the inflation device 12 and displayed on the display 58 providing an indication of a potential tire problem.

The processor 56 (a control unit) of the inflation devices 12, 112 and 212 includes a microcomputer with programming that controls and communicates with the low frequency OUT section 60, the low frequency IN section 62, the high frequency OUT section 64 and the high frequency IN section 66, as discussed above. The processor 56 can also include other conventional components such as an input interface circuit, an output interface circuit, and storage devices such as a ROM (Read Only Memory) device and a RAM (Random Access Memory) device. The microcomputer of the processor 56 is programmed to control the inflation devices 12, 112 and 212.

The internal memory 59 of the processor 56 stores statuses of operational flags and various control data. The internal ROM of the processor 56 stores the programming instructions and operational communications necessary for various operations. The processor 56 is capable of selectively controlling any of the components of the inflation device 12, 112 and 212, in accordance with a control program. It will be apparent to those skilled in the art from this disclosure that the precise structure and algorithms for the processor 56 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

The various elements of the vehicle 18 and the tire 16 are conventional components that are well known in the art. Since these components are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry oui the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A tire pressure inflation system comprising:
an inflation device having a communication portion configured to receive tire pressure signals wirelessly transmitted from a tire pressure sensor disposed within a vehicle tire cavity, and an inflation portion configured to change pressure within the pressurized vehicle tire cavity in response to signals from the tire pressure sensor.

2. The tire pressure inflation system according to claim 1, further comprising: the communication portion of the inflation device is configured to receive low frequency wireless signals.

3. The tire pressure inflation system according to claim 1, wherein
the communication portion of the inflation device includes a wireless signal transmitting section configured to transmit a request signal to the tire pressure sensor requesting tire pressure signals from the tire pressure sensor.

4. The tire pressure inflation system according to claim 3, wherein
the communication portion of the inflation device is configured to send and receive high frequency transmissions.

5. The tire pressure inflation system according to claim 1, wherein
the communication portion of the inflation device is configured to send and receive high frequency transmissions.

6. The tire pressure inflation system according to claim 1, wherein
the communication portion of the inflation device is configured to send and receive both low frequency transmissions and high frequency transmissions.

7. The tire pressure inflation system according to claim 6, wherein
the communication portion of the inflation device is configured to send and receive low frequency transmissions at 125 kHz and high frequency transmissions at one of 315 MHz, 433-434 MHz, 448 MHz, 868 MHz, and 915 MHz.

8. The tire pressure inflation system according to claim 1, wherein
the inflation device is installed within a vehicle that includes at least one tire equipped with a tire pressure sensor such that the inflation device is in wireless communication with the tire pressure sensor.

9. The tire pressure inflation system according to claim 1, wherein
the inflation device is a portable unit having a power cord configured for receiving electrical power from a vehicle.

10. The tire pressure inflation system according to claim 1, wherein
the inflation device is a portable unit having a power cord that receives standard alternating current.

11. The tire pressure inflation system according to claim 1, wherein
the inflation device is a stationary unit having a power cord that receives standard alternating current.

12. The tire pressure inflation system according to claim 1, wherein
the inflation portion includes an air compressor and a manually operated air nozzle configured to couple to a tire valve for fluid communication with the vehicle tire cavity.

13. The tire pressure inflation system according to claim 1, wherein
the inflation device further comprises a microprocessor, memory and a tire sensor diagnostic section configured 10 diagnose operation of a tire pressure sensor.

14. The tire pressure inflation system according to claim 1, further comprising:
a tire pressure sensor disposed within a vehicle tire cavity.

15. The tire pressure inflation system according to claim 14, wherein
the tire pressure sensor includes a wireless transmitter and an automated circuit configured to transmit tire pressure signals at predetermined intervals via the wireless transmitter.

16. The tire pressure inflation system according to claim 15, wherein
the transmitter is a low frequency transmitter.

17. The tire pressure inflation system according to claim 14, wherein
the tire pressure sensor includes a transmitter and an automated circuit configured to transmit tire pressure signals in response to changes in tire pressure within the vehicle tire cavity via the wireless transmitter.

18. The tire pressure inflation system according to claim 17, wherein
the transmitter is a high frequency transmitter.

19. The tire pressure inflation system according to claim 14, wherein
the tire pressure sensor includes a transmitter configured to transmit tire pressure-signals, a receiver configured to receive signals from the communication portion of the inflation device and a circuit configured to transmit tire pressure signals via the wireless transmitter in response to receiving signals from the communication portion of the inflation device.

20. The tire pressure inflation system according to claim 19, wherein
the transmitter of the tire pressure sensor is a high frequency transmitter.
